(19) United States
(12) Patent Application Publication
(10) Pub. No.: US 2008/0176554 A1
(43) Pub. Date: Jul. 24, 2008

(54) WIRELESS DATA DELIVERY MANAGEMENT SYSTEM AND METHOD

(75) Inventors: David B. Gibbons, Redmond, WA (US); John M. Burnette, Seattle, WA (US); Elliott D. Hoole, Sammamish, WA (US)

Correspondence Address: DAVIS WRIGHT TREMAINE, LLP/Seattle, 1201 Third Avenue, Suite 2200, SEATTLE, WA, 98101-3045, US

(73) Assignee: MEDIACAST, LLC, Redmond, WA (US)

(21) Appl. No.: 12/015,313

(22) Filed: Jan. 16, 2008

Related U.S. Application Data
(60) Provisional application No. 60/885,110, filed on Jan. 16, 2007.

(51) Int. Cl. H04Q 7/20

(52) U.S. Cl. 455/423

(57) ABSTRACT

A management system includes a base station controller that uses performance metrics received from one or more associated base stations and/or from other user devices along with service delivery rules to determine when portions of data of a first data transfer are to be sent and/or at what rate the data portions are to be sent from a first base station servicing a first communication cell to a first user device located in the first communication cell thereby seeking to accomplish network availability goals for the first use device receiving the first data transfer, to accomplish network availability goals for other user devices also serviced in the first communication cell by the first base station, and/or to accomplish network availability goals for other user devices serviced in other communication cells by other base stations.

### BACKGROUND OF THE INVENTION

1. Field of the Invention

The present invention is directed generally to wireless communication systems.

2. Description of the Related Art

It has become increasingly evident that the age of mass digital distribution over the Internet has arrived. Content providers are already offering download services for video, music, and games. These new services over packet data networks may necessitate the delivery of very large files. A full-length full screen DVD quality movie could for example be several GBytes in size. Given the current shift toward wireless portability, it is necessary to give special consideration to digital delivery of large files, such as multi-media files including DVD quality movies, over wireless broadband access networks such as UMTS and WiMax.

In wireless networks, transfer of a large amount of data in a single session from a first base station, serving a first cell, to a first user device located in the first cell can cause extensive interference. The interference can be with communication between other base stations, serving other cells, and their respective user devices located in the other cells. Problems can also be had with communication between the first base station and a second user device also located in the first cell and obtaining network access through the first base station.

FIG. 1 depicts an exemplary scenario involving a first conventional cell 10 of wireless service coverage from a first base station 12 and depicts a second conventional cell 14 of wireless service coverage from a second base station 16. The first conventional cell 10 and the second conventional cell 14 are shown to have a coverage overlap area 18. A first subscriber user device 20 and a second subscriber user device 22 are shown to be located in the coverage overlap area 18.

Under the exemplary scenario the first user device 20 is undergoing a first communication with the first base station 12 using a first radio frequency and the second user device 22 is undergoing a second communication with the second base station 16 using a second radio frequency wherein the first radio frequency is at least one of being substantially the same as, or substantially adjacent to, or substantially near to a substantially adjacent frequency of the second radio frequency.

Since the first user device 20 and the second user device 22 are both located in the coverage overlap area 18, the first communication between the first base station 12 and the first user device 20 can cause interference with the second communication between the second base station 16 and the second user device 22. In particular, if the first communication between the first base station 12 and the first user device 20 involves transfer of large amounts of data and thus requires relatively strong signal levels to support relatively large bandwidth communication and/or requires relatively extended periods of communication, the second communication between the second base station 16 and the second user device 22 can suffer from an overly long period of time and/or power level of interference thereby hindering the second communication.

The effective bandwidth capacity of a wireless system is proportional to the ratio of the carrier signal to interference (noise) by the ratio

$$C ∝ \frac{Carrier}{Interference}$$

Consequently, an overly long and/or strong interference with the second communication by the first communication will in effect reduce the bandwidth levels of the second communication thereby degrading the wireless network capacity available to the second subscriber 22. Synonymous to the network congestion perceived in wired systems, this represents wireless congestion in a wide area network.

The following nomenclature will be utilized herein:

| | |
|---|---|
| BER | bit error rate |
| BLER | block error rate |
| CFN | connection frame number |
| CPICH | common pilot channel |
| Ec/No | ratio of energy per modulating bit to the noise spectral density |
| (E)GPRS | enhanced general packet radio service (for GSM) |
| EV-DO | evolution data only |
| GSM | global system for mobile communications |
| HSPA | high speed packet access |
| PCCPCH | primary common control physical channel |
| PCPCH | physical common packet channel |
| PRACH | packet random access channel |
| RSCP | received signal code power |
| RSSI | received signal strength indication |
| RX | receiver |
| SFN | system frame number |
| SIR | signal to interference ratio |
| TX | transmitter |
| UE | user equipment |
| UMTS | universal mobile telephone service |
| UTRA | UMTS terrestrial radio access |
| UTRAN | UMTS terrestrial radio access network |

### BRIEF DESCRIPTION OF THE SEVERAL VIEWS OF THE DRAWING(S)

FIG. 1 is schematic diagram depicting a conventional wireless communication system.

FIG. 2 is a schematic diagram of an exemplary UMTS network having a Gi interface.

FIG. 3 is a schematic diagram of a wireless communication system according to the present invention.

FIG. 4 is a schematic diagram of an exemplary neural network.

FIG. 5 is a schematic diagram of an exemplary version of the system of FIG. 3 having incorporated a neural network.

FIG. 6 is a schematic diagram showing link performance metrics being fed into a neural network.

FIG. 7 is a schematic of an exemplary structure of an activation function.

FIG. 8 is a graph of exemplary sigmoid functions.

FIG. 9 is a schematic of an exemplary three-tier cell cluster.

FIG. 10 is a schematic depicting data gathering from surrounding cells.

FIG. 11 is a schematic depicting spectrum borrowing.

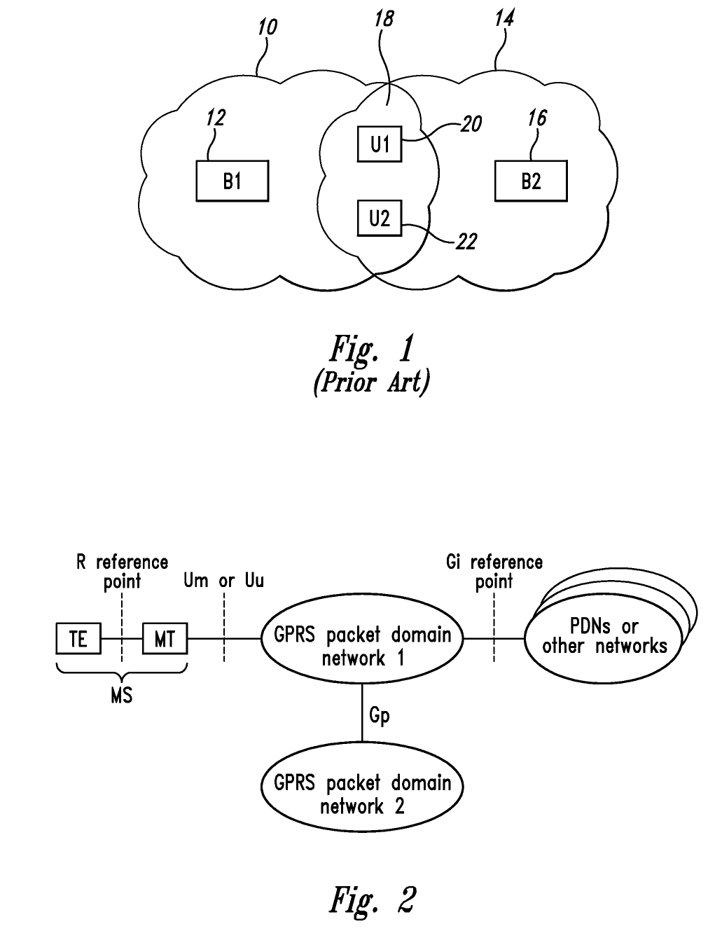

### DETAILED DESCRIPTION OF THE INVENTION

A wireless data delivery management system and method is described herein to control non-real-time delivery of data from a base station to a wirelessly connected subscriber user devices over a wireless network. In some implementations the wireless network provides delivery capability through use of a wireless IP connection. The wireless management system can be described as using an adaptive bandwidth management approach for management of spectrum interference for wireless broadband providers to address interference issues beyond that typical with conventional DSL and Cable networks.

The management system includes a base station controller that uses performance metrics received from one or more associated base stations and/or from other user devices along with service delivery rules to determine when portions of data of a first data transfer are to be sent and/or at what rate the data portions are to be sent from a first base station servicing a first communication cell to a first user device located in the first communication cell thereby seeking to accomplish network availability goals for the first use device receiving the first data transfer, to accomplish network availability goals for other user devices also serviced in the first communication cell by the first base station, and/or to accomplish network availability goals for other user devices serviced in other communication cells by other base stations.

As is conventionally known, implementations of a wireless data network can be a public land mobile network operated by a mobile network operator typically in spectrum licensed by the mobile network operator for the purpose of delivering wireless services to network subscribers. Public land mobile networks use a variety of air interface standards, such as E)GPRS, UMTS HSPA, cdma2000 EV-DO, and IEEE 802.16—WiMAX, to deliver their services via packetized data.

Typically for a public land mobile network, portions of a first licensed radio frequency spectrum can each be assigned for use with a different one of a first plurality of communication cells (also known as cluster of cells). At least some of the cells of the first plurality may be adjacent to at least one of the second plurality of cells and others of the first plurality may not be adjacent to any cells of the second plurality. For each of those cells of the second plurality of cells that are not adjacent to any of the cells of the first plurality of cells, a portion of first spectrum can also be used.

For each of those cells of the second plurality of cells that are adjacent to one or more cells of the first plurality a portion of a second spectrum may be used or a portion of the first spectrum may be used if that portion of the first spectrum is used by a cell of the first plurality that is far enough away from the cell of the second plurality. Typically as other pluralities of cells are located farther from the first plurality of cells, each of the cells of the other pluralities can use a portion of the first spectrum without regard to what portion of the first spectrum is used by the cells of the first plurality.

As a result, any portion of the first spectrum can be used by more than one cell of more than one plurality depending upon their location. For interference mitigation purposes, communication cells can be distinguished as belonging to one of a plurality of tiers. For instance, a first tier can be composed of a first cell of interest. A second tier can be composed of second communication cells that are located adjacent to the first cell. A third tier can be composed of all communication cells located adjacent to at least one of the second communication cells. Co-channel interference management typically focuses inquiry to a three tier structure since this is a good practical limit for frequency reuse techniques.

For delivering packetized data to subscriber devices, public land mobile networks have a standardized interface to a packet data network. In the case of UMTS networks, this interface is called Gi as shown in FIG. 2. When a public land mobile network subscriber user device is receiving data from a source outside the public land mobile network, that data comes through the Gi interface, traverses the core and access networks and is delivered to the subscriber device through the air interface.

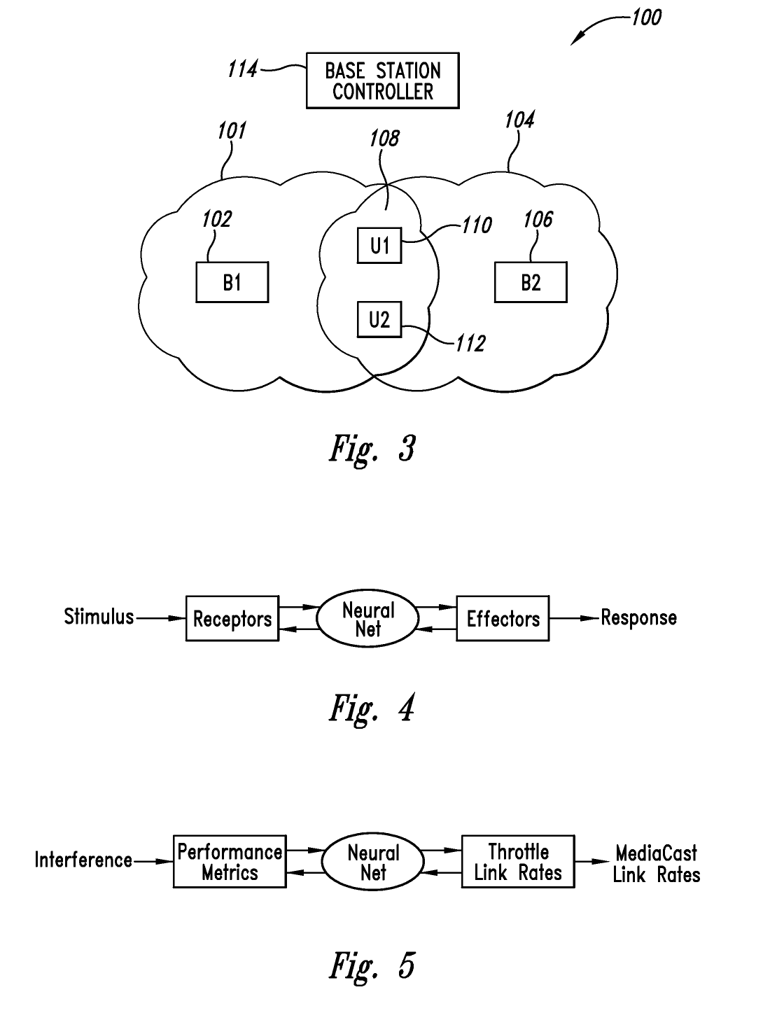

An implementation of the wireless data delivery management system 100 is shown in FIG. 3 as having a first communication cell 101 serviced by a first base station 102, a second communication cell 104 serviced by a second base station 106, an overlap coverage area 108 which has portions of both the first communication cell and the second communication cell, a first user device 110 undergoing a first communication with the first base station, a second user device undergoing a second communication with the second base station, and a base station controller. As this implementation can apply to a public land mobile network plan, the base station controller 114 (also known as a network management system) is used by a mobile network operator to manage the public land mobile network.

The base station controller 114 can use one or more performance metrics associated with communication between one or more base stations including the first base station 102 and the second base station 106 and user devices including the first user device 110 and the second user device 112 to determine how to control the base stations including the first base station and the second base station. Alternatively, more than one instance of the base station controller 114 may exist, such as one instance dedicated to controlling each base station. Various metrics, such as those listed in Table 1, are conventionally available from user equipment, such as the user devices, and from one or more terrestrial radio networks. One or more of the various metrics can be used by the base station controller 114 in part to determine how to control associated one or more base stations.

TABLE 1
Exemplary Performance Metrics

| UE Measurement Abilities | UTRAN Measurement Abilities |
|---|---|
| CPICH RSCP | Received Total Wideband Power |
| PCCPCH RSCP | SIR |
| UTRA Carrier RSSI | SIR Error |
| GSM Carrier RSSI | Transmitted Carrier Power |
| CPICH Ec/No | Transmitted Code Power |
| Transport Channel BLER | Transport Channel BER |
| UE Transmitted Power | Physical Channel BER |
| SFN-CFN Observed Time | Round Trip Time |
| Difference | |
| SFN-SFN Observed Time | UTRAN GPS Timing of Cell Frames |
| Difference | for UE Positioning |
| UE RX-TX Time Difference | PRACH/PCPCH Propagation Delay |
| Observed Time Difference of | Acknowledged PRACH Preambles |
| GSM Cell | |
| UE GPS Timing of Cell Frames | Detected PCPCH Access Preambles |
| for UE Positioning | |
| UE GPS Code Phase | Acknowledged PCPCH Access |
| | Preambles |
| | SFN-SFN Observed Time Difference |

An exemplary scenario includes the base station controller 114 receiving performance metric information indicating current quality of service from the second user device 112 through the second base station 106. Service delivery rules are used by the base station controller 114 in conjunction with the received performance metrics to determine and transmit control instructions to the first base station 102 in order to effect a desired outcome such as mitigation of congestion on a particular frequency. For instance, if the base station controller 114 receives performance metric information from the second user device 112 that indicates a degradation of service for the second user device that exceeds specifications embodied in the service delivery rules, the first base station 102 will be instructed by the base station controller to temporarily reduce operation such as by curtailing transmissions such as through decreasing transmission power or change its transmission rate, or by ceasing transmission altogether for a time to decrease or cease interference with communication by the second user device 112 with the second base station 106.

The base station controller 114 can also manage the large data transmission of the first base station 102 to the first user device 110 according to one or more radio resource management functions. For instance, the second communication cell 104 may experience increased interference from the first base station 102 transmitting to the first user device 110, but the controlling radio resource management function overseeing the cell cluster that includes both the first cell 101 and the second cell 102 as implemented through the base station controller 114 may determine that there is no actual degradation of service to the second cell due to transmission by the first base station so that data transfer from the first base station to the first user device may continue unabated.

The result is that the second user device 112 may no longer experience a poor carrier to interference ratio during its time allotment of the signal space and consequently its data throughput capacity increases. When the second subscriber 112 is no longer requiring bandwidth the first base station 102 can then be by the base station controller 114 to begin or increase transmission again to the first user device 110. Alternatively and/or additionally, the first base station 102 can begin to ramp up throughput of transmission to the first user device 110 over a period of time until the first base station is again instructed by the base station controller to reduce operation. Consequently, the function of first user device 110 is gated to not interfere with or degrade the system performance in the second cell 104. For background delivery tasks such as large file push and store functions this can be a particularly beneficial solution.

Alternatively and/or additionally, the first base station 102 may have a delivery deadline for the data transfer to the first user device 110 so that even though transmissions from the first base station to the first user device is causing interference in the second cell 104, such as with communication by the second user device 112 with the second base station 106, the radio resource management function used by the base station controller 114 may choose to not alter the rate or transmission level at the first base station in order to meet the delivery deadline.

The base station controller 114 can be configured to implement service delivery rules framed in terms of the cell cluster associated base stations such as including the first base station 102 and the second base station 106 and can have configuration parameters that would include but is not limited to terrain, foliage, buildings, subscriber density and spectrum availability.

The service delivery rules used by the base station controller 114 can be updated regularly or in near real-time to adapt to the changing dynamics of the associated cell network or base station cluster, such as the cell cluster including the first cell 101 and the second cell 104 that the base station controller is managing. For example, the base station controller 114 can routinely cause the first base station 102 to transmit data in varying degrees to user devices in the first cell 101, such as the first user device 110, to measure and understand impact to neighboring cell sites, such as the second cell 104.

Under an exemplary implementation the base station controller 114 can receive quality of service reports from user devices, such as the second user device 112. As described above, the quality of service reports can be provided directly from the user device or via the respective base station. Those skilled in the art will appreciate that quality of service can be associated with a particular user for a given time. For example, some applications require wide bandwidth real-time connectivity, which generally requires a higher quality of service level.

Other activities may not require the same degree of bandwidth and connectivity, so are satisfied by a lower quality of service level. However, those skilled in the art will appreciate that the quality of service can be measured in a variety of different ways. For example, the quality of service may be determined on the basis of bit error rate, signal to noise ratio, received signal strength index, carrier to noise ratio, or the like. There are a number of different parameters that can be measured to determine whether a particular subscriber is receiving data at an adequate bandwidth and with sufficiently low error rates. The quality of service may be determined on the basis of one or more of these parameters or other parameters known in the art.

The base station controller 114 determines whether the quality of service for each of the subscribers exceeds some predetermined value. As noted above, the quality of service value may be determined on the basis of the presently executing application (e.g., real-time high bandwidth connectivity versus low bandwidth requirement applications). If the quality of service value for a particular user device exceeds the predetermined value, no control activity need take place. That is, the various base stations continue to transmit at their present values. If the quality of service value does not exceed the predetermined value, it will be necessary for the base station controller 114 to take action to reduce or eliminate the undesirable interference.

The base station controller 114 determines the interference source and sends a reduce operation command to the interfering base station. As noted above, the reduce operation command can be implemented in a variety of ways. At one extreme, the interfering base station may cease transmission to a particular user device altogether. In a less extreme control measure, the base station controller 114 may instruct the interfering base station to reduce power or to reduce bandwidth by transmitting fewer messages to a particular user device or transmitting at a lower data rate. The base station controller 114 can be configured to control communication by adjusting at least one of the following: data delivery rate, transmit power, modulation and coding of a communication channel, spreading gain of a communication channel, the spreading code(s) used for the communication channel, time resource(s) used for communication channel, and frequency resource(s) used for communication channel.

Furthermore, the base station controller 114 can be configured to control communication based upon at least one performance metric being at least one of the following: signal to interference plus noise ratio (SINR) of communication channel, signal to interference ratio (SIR) of communication channel, received signal strength indication (RSSI), received signal code power (RSCP), communication channel bit error rate (BER), communication channel block error rate (BLER), IP congestion of data connection, and pilot channel quality indication.

This process continues indefinitely during operation of the system. Thus, the base station controller 114 can be configured to continuously monitor activities of all base stations within its control area and acts to reduce interference when quality of service levels become unacceptable.

Initially, under control of the base station controller 114, the base stations, such as the first base station 102 and the second base station 106, transmit data to one or more of the user devices, such as the first user device 110 and the second user device 112, respectively, within its area of coverage. If no reduce operation off command is received from the base station controller 114, this process continues unabated. If a particular base station receives a reduce operation command from the base station controller 114, the base station reduces operations in some manner as described to one or more user devices. The base station controller 114 may operate in a manual mode to determine a time at which the reduce operation can cease.

In this reduce operation manual mode, the base station controller 114 sends a command to the base station that has reduced operation to resume full operation. In this manual mode of operation, the base station may now resume full transmission to the user device. Alternatively, if a base station has received a reduce operation command, it may slowly ramp up transmission to the associated user device over time. In this mode of operation, the base station automatically resumes transmission and increases transmission until such time as it may receive another reduce operation command from the base station controller 114. Thus, the base station controller 114 can dynamically monitor all activities with its control area to act quickly to mitigate or eliminate interference. The base station controller 114 subsequently restores transmission at a time when interference is less problematic.

Neural networks have seen significant use in pattern recognition and non-linear control systems. What is a neural network, and why is it appropriate for this type of problem? The answer to the first question comes from Simon Haykin's book, Neural Networks: A neural network is a massively parallel distributed processor that has a natural propensity for storing experimental knowledge and making it available for use. It resembles the brain in two respects: Knowledge is acquired by the network through a learning process. Interneuron connection strengths known as synaptic weights are used to store the knowledge.

Next, let's look at what traditional computing systems are good at and not so good at:

| Good at | Not so good at |
|---|---|
| Fast arithmetic | Interacting with noisy data |
| | or data from the |
| | environment |
| Doing precisely what the | Massive parallelism |
| programmer tells it to do | |
| | Fault tolerance |
| | Adapting to circumstances |

Neural network systems are most helpful where it is hard to formulate an explicit solution mathematically, yet there are many examples of behavior that is required, and a need exists to select a structure out of existing data.

As depicted in FIG. 4, a neural network uses input data from input receptors and produces a response that is output via effectors. In general, there can be feedback from the output to the input to affect the overall system. The base station controller 114 can incorporate a neural network by using performance metrics as the data input and desired reduce operation of base stations, such as the first base station 102, as the output response to the interference conditions as depicted in FIG. 5.

In general, it would be desirable to observe the interference in the wireless network and adjust the base station link rates accordingly. Greater data traffic contributes to the overall interference, so reducing overall data traffic reduces total interference. In some cases, there will be a significant amount of interference created by other data traffic, and throughput on some links will be suspended due to this condition to keep the overall interference as low as possible. In other cases, there will be minimal interference and throughput on those links will ratchet up to take advantage of this condition.

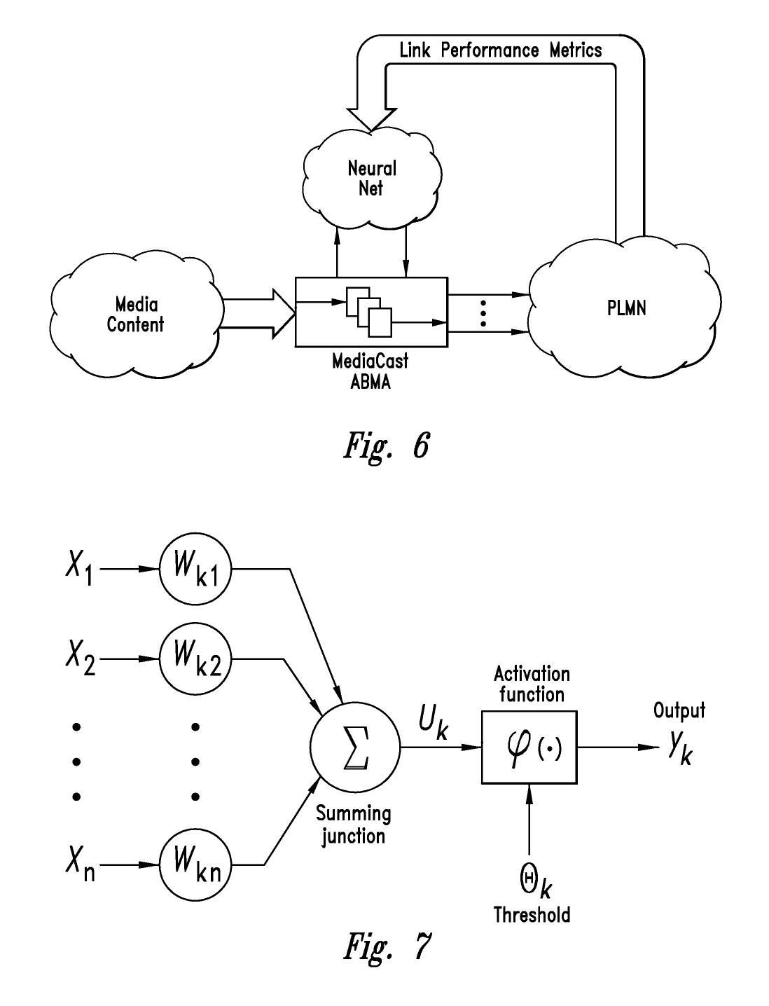

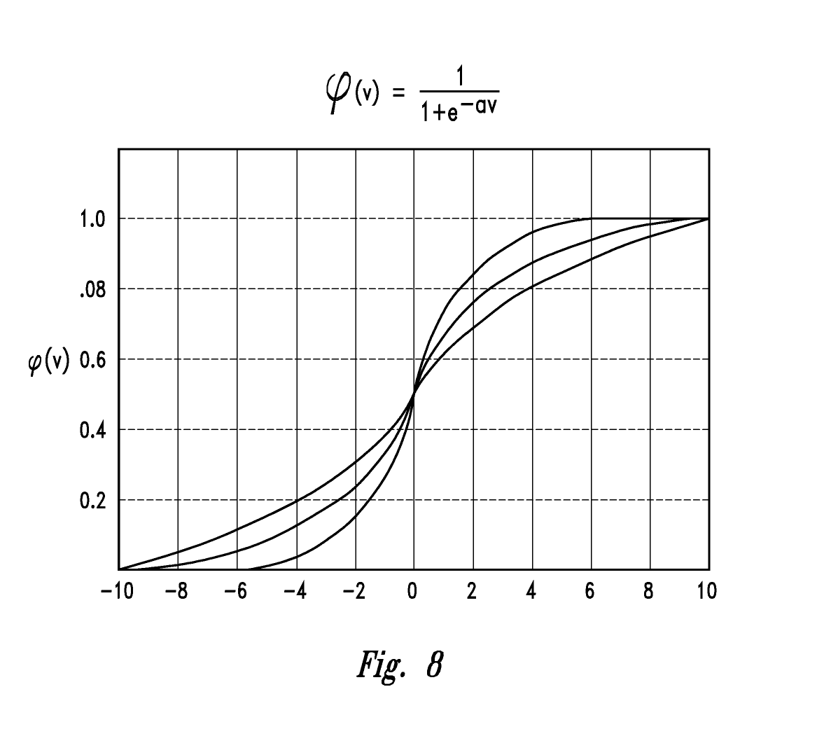

Link performance metrics can be obtained from the base station controller 114. As depicted in FIG. 6, these are fed into the neural network along with indications of congestion to allow the neural network of the base station controller 114 to determine when it is necessary to react to interference conditions and throttle respective base station link throughputs accordingly.

Like the biological mass the neural network is modeled after, it is composed of neurons. Each neuron takes weighted input data from multiple sources and produces an output according to an activation function with an exemplary structure depicted in FIG. 7. The activation function can be any number of linear or non-linear function including steps and simple lines, but a very useful function is a sigmoid which is written such as the exemplary function shown in FIG. 8 where a is the slope parameter of the sigmoid function. By varying a we can obtain a function that is virtually linear or virtually a step or something in-between as shown in FIG. 8.

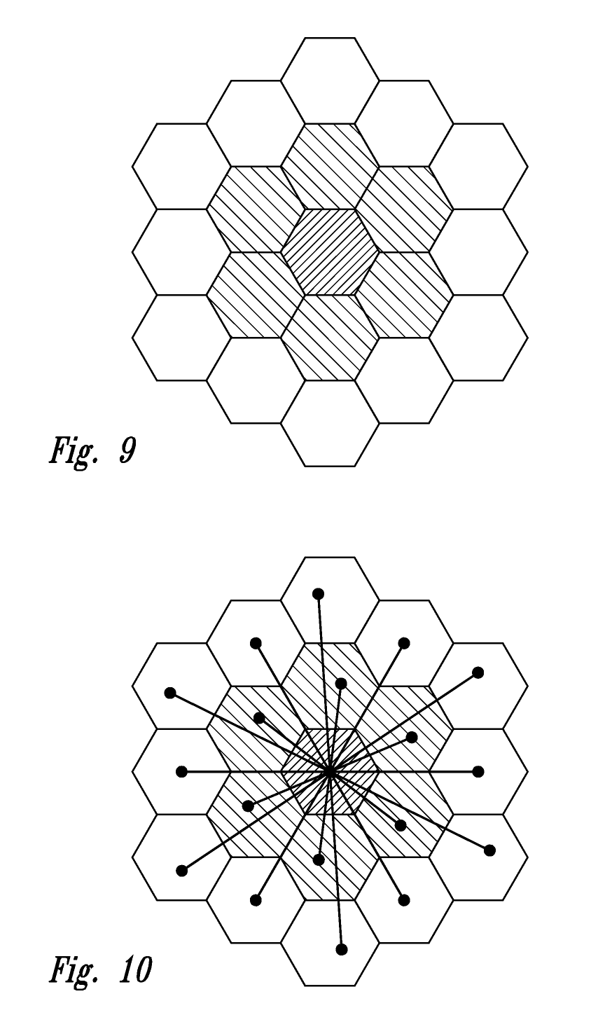

The basic topological construct we'll use for our neural network scheme is a three-tier cell cluster as shown in FIG. 9. This three tier cluster is a common approach to interference management in wireless networks. Larger clusters or different cluster patterns could be used to accommodate various resource reuse patterns, but this 19-cell cluster is what we'll use for this discussion.

The dark cell in the middle of the cluster represents the cell with the link under observation. Performance metrics are gathered from the cells in the two blue rings around the inner-most cell. These performance metrics are somewhat system-dependent, but they are measurements of signal strength, signal-to-noise-plus-interference ratio, and other similar parameters. The parameters will be discussed further in the next section. Gathering data from the surrounding cell leads to the conceptual representation depicted in FIG. 10. Of course data is gathered from the surrounding cells for every link under observation, which gives multiple overlapping cluster patterns and cluster patterns which move as the links under observation move from cell to cell.

Frequency Reuse and Spectrum Borrowing

A cellular network is composed of cell sites which together cover a much greater geography than any one of them does. Mobile network operators (MNO's) typically operate their networks in licensed spectrum which is assigned by the FCC in geographical markets. In first, second, and some third generation cellular networks, the available spectrum is sub-divided into channels, and each cell uses only a portion of the total spectrum licensed by the MNO. This is done to create a manageable amount of radio interference between cells and provide an overall capacity gain throughout the network.

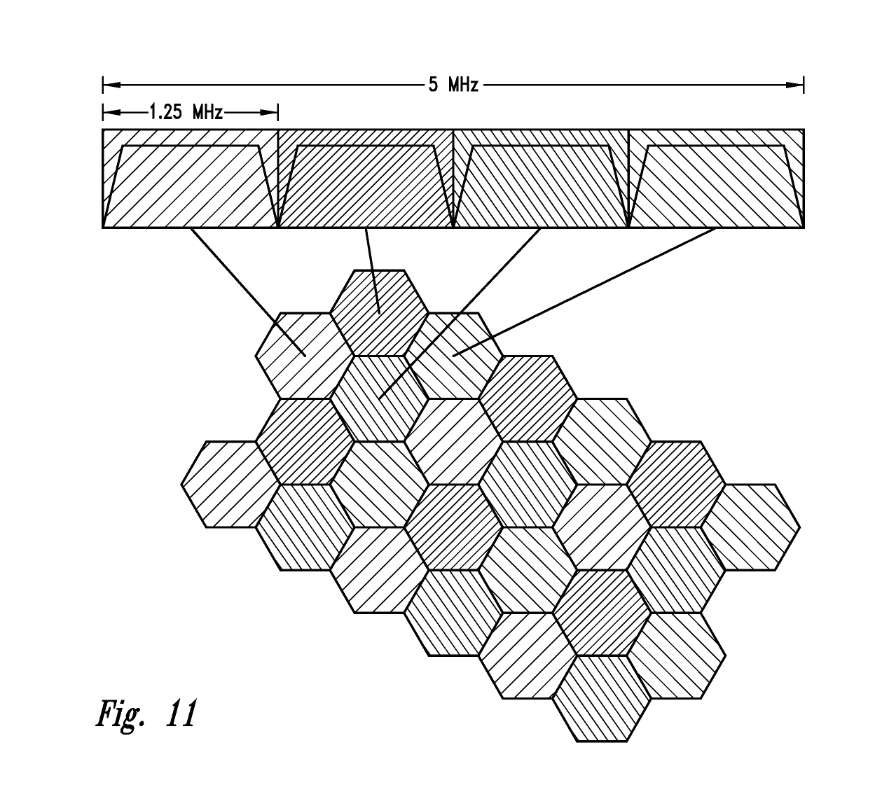

An example of this is shown in FIG. 11. The total 5 MHz of spectrum is divided into 4 1.25 MHz channels, and each channel is used in a 4-cell cluster. The cluster is reused throughout the network.

Spectrum borrowing is the concept of using one cell's assigned frequency resources in another cell to temporarily increase the capacity of the borrowing cell. It is important that any interference created by spectrum borrowing is non-impacting to the network. In some implementations the system 100 can use aspects of this spectrum borrowing to shift capacity around in the network to meet various demands and quality of service commitments.

In one or more various implementations, related systems include but are not limited to circuitry and/or programming for effecting implementations of such as the base station controller 114. The circuitry and/or programming can be virtually any combination of hardware, software, and/or firmware configured to effect implementations depending upon the design choices of the system designer.

The foregoing provides exemplary descriptions and thus contains, by necessity; simplifications, generalizations and omissions of detail; consequently, those skilled in the art will appreciate that the summary is illustrative only and is not intended to be in any way limiting. Those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various depictions of devices and processes with one or more functions. It will be understood by those within the art that each function and/or operation within such depictions can be implemented, individually and/or collectively, by a wide range of hardware, software, firmware, or virtually any combination thereof.

Those skilled in the art will recognize that implementations disclosed herein, in whole or in part, can be equivalently implemented in standard or custom Integrated circuits, as one or more computer programs running on one or more computers (e.g., as one or more programs running on one or more data processing systems), as one or more programs running on one or more controllers (e.g., microcontrollers) as one or more programs running on one or more processors e.g., microprocessors, as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of the present invention are capable of being distributed as a program product in a variety of forms, and that an illustrative implementation of the present invention applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analogue communication links using TDM or IP based communication links (e.g., packet links).

In a general sense, those skilled in the art will recognize that the various implementations described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into data processing systems. That is, the devices and/or processes described herein can be integrated into a data processing system via a reasonable amount of experimentation.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. A system comprising:
a first wireless base station;
a wireless user device configured to undergo a first communication with the first base station
a second wireless base station;
a second user device configured to undergo a second communication with the second base station; and
a base station controller configured to control communication between the first wireless base station and the first user device based upon at least one performance metric related to the second communication and based upon at least one service delivery rule.

2. The system of claim 1 wherein the first wireless base station is of a first tier of a cluster of base stations and the second wireless base station is of a second tier of a cluster of base stations.

3. The system of claim 1 wherein the base station controller is configured to control communication based upon at least a neural network.

4. The system of claim 1 wherein the base station controller is configured to control communication based upon the at least one service delivery rule having configuration parameters that include at least one of terrain, foliage, buildings, subscriber density and spectrum availability.

5. The system of claim 1 wherein the base station controller is configured to control communication by adjusting at least one of the following: data delivery rate, transmit power, modulation and coding of a communication channel, spreading gain of a communication channel, the spreading code(s) used for the communication channel, time resource(s) used for communication channel, and frequency resource(s) used for communication channel.

6. The system of claim 1 wherein the base station controller is configured to control communication based upon at least one performance metric being at least one of the following: signal to interference plus noise ratio (SINR) of communication channel, signal to interference ratio (SIR) of communication channel, received signal strength indication (RSSI), received signal code power (RSCP), communication channel bit error rate (BER), communication channel block error rate (BLER), IP congestion of data connection, and pilot channel quality indication.

7. The system of claim 1 wherein the base station controller reallocates a portion of a radio frequency spectrum for the first base station to at least in part control communication between the first wireless base station and the first user device.

8. A method comprising:
transmitting a first communication between a wireless user device and a first wireless base station;
transmitting a second communication between a second user device and a second wireless base station; and
controlling communication between the first wireless base station and the first user device based upon at least one performance metric related to the second communication and based upon at least one service delivery rule.

9. The method of claim 8 wherein the first wireless base station is of a first tier of a cluster of base stations and the second wireless base station is of a second tier of a cluster of base stations.

10. The method of claim 8 wherein controlling communication is based upon at least a neural network.

11. The method of claim 8 wherein controlling communication is based upon the at least one service delivery rule having configuration parameters that include at least one of terrain, foliage, buildings, subscriber density and spectrum availability.

12. The method of claim 8 wherein controlling communication is performed by adjusting at least one of the following: data delivery rate, transmit power, modulation and coding of a communication channel, spreading gain of a communication channel, the spreading code(s) used for the communication channel, time resource(s) used for communication channel, and frequency resource(s) used for communication channel.

13. The method of claim 8 wherein controlling communication is based upon at least one performance metric being at least one of the following: signal to interference plus noise ratio (SINR) of communication channel, signal to interference ratio (SIR) of communication channel, received signal strength indication (RSSI), received signal code power (RSCP), communication channel bit error rate (BER), communication channel block error rate (BLER), IP congestion of data connection, and pilot channel quality indication.

14. The method of claim 8 wherein controlling communication is performed at least in part by reallocation of a portion of a radio frequency spectrum.

15. A computer readable media containing instructions to implement a method comprising:
transmitting a first communication between a wireless user device and a first wireless base station;
transmitting a second communication between a second user device and a second wireless base station; and
controlling communication between the first wireless base station and the first user device based upon at least one performance metric related to the second communication and based upon at least one service delivery rule.

16. The media of claim 15 wherein the first wireless base station is of a first tier of a cluster of base stations and the second wireless base station is of a second tier of a cluster of base stations.

17. The media of claim 15 wherein controlling communication is based upon at least a neural network.

18. The media of claim 15 wherein controlling communication is based upon the at least one service delivery rule having configuration parameters that include at least one of terrain, foliage, buildings, subscriber density and spectrum availability.

19. The media of claim 15 wherein controlling communication is performed by adjusting at least one of the following: data delivery rate, transmit power, modulation and coding of a communication channel, spreading gain of a communication channel, the spreading code(s) used for the communication channel, time resource(s) used for communication channel, and frequency resource(s) used for communication channel.

20. The media of claim 15 wherein controlling communication is based upon at least one performance metric being at least one of the following: signal to interference plus noise ratio (SINR) of communication channel, signal to interference ratio (SIR) of communication channel, received signal strength indication (RSSI), received signal code power (RSCP), communication channel bit error rate (BER), communication channel block error rate (BLER), IP congestion of data connection, and pilot channel quality indication.

21. The media of claim 15 wherein controlling communication is performed at least in part by reallocation of a portion of a radio frequency spectrum.
